(19) United States
(12) Patent Application Publication
(10) Pub. No.: US 2007/0273135 A1
(43) Pub. Date: Nov. 29, 2007

(54) All-terrain light motor vehicle

(75) Inventor: Pierre Labadens, Saint Pierre D'Irube (DE)

Correspondence Address: YOUNG & THOMPSON, 745 SOUTH 23RD STREET, 2ND FLOOR, ARLINGTON, VA, 22202, US

(73) Assignee: S. Pace Moto, Bayonne (FR)

(21) Appl. No.: 10/592,532

(22) PCT Filed: Mar. 16, 2005
(86) PCT No.: PCT/FR05/50167

§ 371 Date: Sep. 12, 2006

(30) Foreign Application Priority Data
Mar. 18, 2004 (FR) 0450543

(51) Int. Cl. B60R 9/06

(52) U.S. Cl. 280/769

(57) ABSTRACT

A quad-type light all-terrain motor vehicle provided with a rear platform (1) which is carried by the vehicle frame (102) and used for transporting a person and/or a material and a support frame (15). The vehicle can be used for transporting and rescuing people in distress and/or intervening in the areas non-accessible for conventional rescue vehicles.

The invention relates to an all-terrain light motorized vehicle.

The invention is applicable to vehicles of the “quad” category, which is to say quadricycled with a motor or of the self-propelled type or the like with four or six wheels of which at least two opposite wheels are motor-driven. These vehicles can be provided with a steering wheel or handlebars, the occupants are seated either side by side or one behind the other.

Until now, the present quadricyles are only of an all-terrain type called non-homologous, namely a hybrid permitted on roads and still all-terrain, this latter being called homologous.

Such vehicles are used for amusement purposes such as Trial, Raid or professionally for agriculture or forestry.

No other application beyond the sport context and leisure has been envisaged until now.

The applicant proposes a new application for an all-terrain light motorized vehicle, consisting in using it as a transport vehicle for rescuing persons in difficulty and/or intervening in places inaccessible to conventional rescue vehicles.

The present invention proposes an all-terrain light motorized vehicle permitting arriving rapidly on the scene of an accident difficult to access, such as seashores or lakes, forests, mountains, in summer or winter including snowy regions, country regions, and to transport a treatment person: doctor, rescuer and/or a person in trouble: sick, injured.

The present invention has more particularly for its object an all-terrain light motorized vehicle principally characterized in that it comprises a rear platform carried by the frame of the vehicle, for the transport of a person and/or material.

According to another characteristic, the vehicle comprises a stretcher support fixed to the rear of the seat of the driver, in front of the platform.

The platform comprises a chassis which is secured to the frame of the vehicle.

The platform moreover comprises one or several panels or grilles for protection of the passenger.

The platform comprises an adjustable backrest mounted on a dorsal rod.

The stretcher support comprises a chassis secured to the luggage carrier of the vehicle or to the frame of the vehicle.

The stretcher support chassis can be telescopic, it comprises in this case a chassis in two parts of which one is removable, retractable so as to impart a “roadway” position and a “human transport” position.

The stretcher support chassis comprises means for locking the removable portion of the chassis in its position for transporting a person.

The stretcher support moreover comprises means for securing a strap for holding a person disposed on a stretcher on the stretcher carrier.

Other particularities and advantages of the invention will become clearly apparent from a reading of the description which is given hereafter and which is given by way of illustrative and non-limiting example and with respect to the drawings, in which:

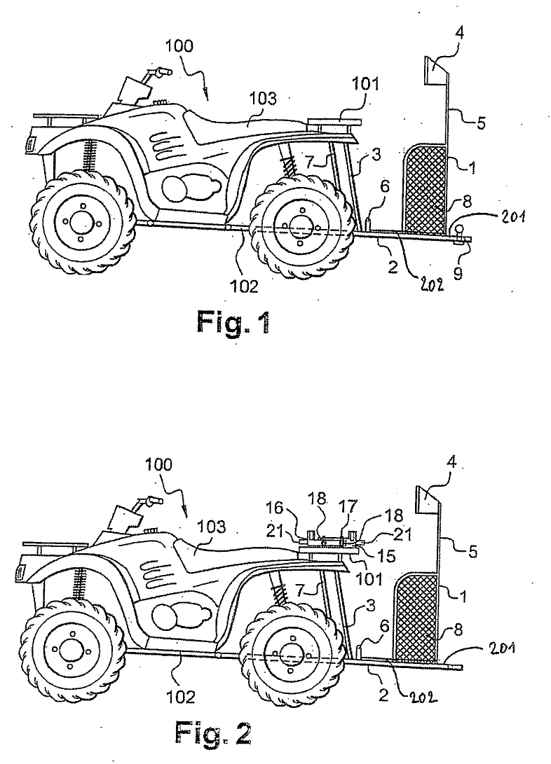

FIG. 1 shows a side view of the motor vehicle according to an embodiment of the present invention,

FIG. 2 shows the motor vehicle according to another embodiment in a “roadway” position,

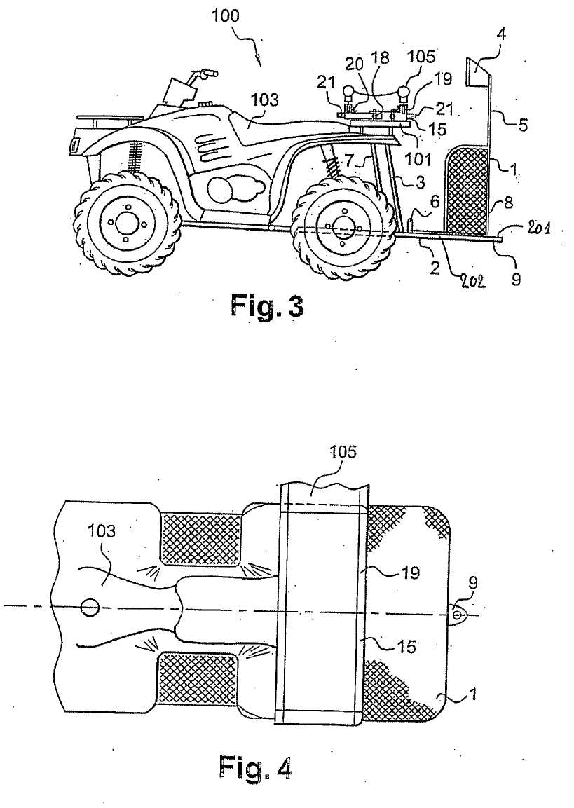

FIG. 3 shows the motor vehicle according to FIG. 2, in the “transport of an injured person” position,

FIG. 4 shows a plan view of the vehicle according to FIG. 3.

The motor vehicle 100 shown and given by way example in FIGS. 1 to 4 is a quadricycle of the “quad” type.

In FIG. 1, there is shown a first embodiment consisting in providing the vehicle at the rear, with a platform 1 carrying people or material. The vehicle thus permits a rapid transport of a person/material over any broken terrain and/or any difficultly accessible location, the person standing on the platform.

The platform 1 comprises a chassis 2 fixed to the support frame 102 of the vehicle. The platform is thus secured to the “quad”, the chassis 2 preferably comprises four or more securement points to the frame. The securement of the platform can be reinforced if needed by radius rods 7.

The platform is secured to the “quad” but is nevertheless removable, the securement being provided in a manner so as to permit dismounting.

In a practical way, the chassis 2 of the platform comprises at least two longitudinal arms 201 perpendicular to the axle of the vehicle wheels, these arms 201 are fixed to the frame 102 of the vehicle 100.

Preferably, the chassis of the platform 2 is fixed removably to the support frame 102.

The platform moreover comprises, carried by the chassis, a support plate or grille 202 and protective panels or grilles 8 on opposite sides of this plate 202.

An adjustable backrest 4 is carried by a dorsal bar 5. A footrest 6 permits the rescuer to brace himself during transport and have his hands free.

The protection grilles 8 avoid any projections due to rotation of the wheels and to movement of the vehicle.

Moreover, the lateral protective panels or grilles 8 prevent the legs of the rescuer from moving outwardly.

The dorsal bar 5 can moreover serve for support for tools or apparatus useful for the mission in progress.

The chassis 2 can comprise at the rear of the platform an attachment point 9 (ball or hasp) for the possible anchoring or a light trailer whose maximum weight is established as a function of the power of the “quad”.

In FIG. 2 there is shown a second embodiment consisting in providing the motor vehicle 100, moreover with a stretcher support 15. This stretcher support 15 comprises a chassis fixed to the rear of the seat 103 of the driver. This chassis 15 is preferably fixed on the luggage carrier 101 of the vehicle. It could also be fixed on the frame 102 of this vehicle.

Thus the vehicle 100 permits finding and rapidly transporting a person placed on a stretcher (an injured person or one who is sick), over terrain that is not easily accessible for any other vehicle.

The stretcher support 15 can be retractable and comprise an “injured transport” position and a “roadway” position.

For long distances, the support 15 is adjusted to the “roadway” position that is less cumbersome than the “injured transport” position.

To this end, the chassis 15 is in two parts of which a movable part 16 is disposed on the fixed chassis 15 and can slide on this latter.

The movable chassis 16 is guided by the pin 17 and is locked in end positions by cotters 18 located to the left and right of the chassis.

The stretcher 15 raised by two rescuers will be placed in slides 19 and the wheels of the stretcher are blocked by locks located at the diagonally opposite ends 20 of the rails.

The holding straps for the injured person on the vehicle are fixed to the chassis 15 by loops 21 welded on opposite sides of the chassis 15.

Of course, in the case of the use of a “quad” or other similar vehicle comprising a wide rear addition, there can be used a non-retractable chassis 15 so as to limit the manipulations for placing it in use for reception of the stretcher.

The motor vehicle thus avoids great physical strain by the rescuers before the procedure, letting them thus use all of their faculties for analysis and for easy manual stretchering, the whole permitting a great saving of time for taking charge of an injured person and his quickest arrival at medical facilities.

From a logistical standpoint, the motor vehicle can serve for looking for supplemental people to complete the initial rescue team (example: a doctor), as a mobile observation station as on large beaches or in sports, the observer standing on the platform whilst the driver concentrates on driving.

Firemen can transport material and unroll hoses from the “quad” while traveling over regions difficult of access for their usual vehicles.

The fireman standing on the platform carries out the unrolling of hoses transported on the rear luggage carrier 101 of the “quad”, the driver remaining concentrated on driving. In this case, an additional swinging front chassis can be provided to permit transporting a supplemental supply of hose.

Thus when the vehicle is provided with all the accessories which have been described, it offers the possibility of being able to treat the injured person or persons in place thanks to the onboard material and to transport an injured person on a stretcher itself strapped to the vehicle, one rescuer driving the vehicle, the other standing on the platform ensuring observation of the injured person until a better equipped unit can take over, such as at a helicopter station or where a conventional ambulance is located.

1. All-terrain light motorized vehicle comprising a support frame (102), principally characterized in that it moreover comprises a rear platform (1) carried by the support frame (102) of the vehicle, the platform (1) comprising for this purpose a chassis (2) fixed to said frame (102), said platform thus permitting the transport of a person and/or of material.

2. All-terrain light motorized vehicle according to claim 1, characterized in that the chassis (2) of the platform (1) comprises at least two longitudinal arms (201) perpendicular to the axis of the wheels of the vehicle, fixed to the frame (102) of the vehicle.

3. All-terrain light motorized vehicle according to claim 1, characterized in that the platform (1) comprises, carried by its chassis (2) said chassis being fixed removably to the support frame, a support plate or grille (202) and protective panels or grilles (8) on opposite sides of this plate (202).

4. All-terrain light motorized vehicle according to claim 1, characterized in that the platform (1) comprises an adjustable backrest (4) mounted on a dorsal rod (5).

5. All-terrain light motorized vehicle according to claim 1, characterized in that it comprises a stretcher support (15) fixed to the rear of the seat (103) of the driver and in front of the platform.

6. All-terrain light motorized vehicle according to claim 5, the vehicle comprising a luggage carrier characterized in that the stretcher support (15) comprises a chassis secured to the luggage carrier (101) of the vehicle.

7. All-terrain light motorized vehicle according to claim 6, characterized in that the stretcher support (15) comprises a chassis secured to the frame of the vehicle (102).

8. All-terrain light motorized vehicle according to claim 5, characterized in that the stretcher support (15) is telescopic, it comprises a chassis (15) in two parts of which one is a removable part (16) retractable so as to provide a “roadway” position and a “person transport” position.

9. All-terrain light motorized vehicle according to claim 8, characterized in that the stretcher support (15) comprises locking means (18) of the removable part of the chassis in its “person transport” position.

10. All-terrain light motorized vehicle according to claim 6, characterized in that the chassis (15) comprises securement means (21) for a strap for holding a person placed on the stretcher (105) in place on the stretcher carrier.

11. All-terrain light motorized vehicle according to claim 2, characterized in that the platform (1) comprises, carried by its chassis (2) said chassis being fixed removably to the support frame, a support plate or grille (202) and protective panels or grilles (8) on opposite sides of this plate (202).

12. All-terrain light motorized vehicle according to claim 6, characterized in that the stretcher support (15) is telescopic, it comprises a chassis (15) in two parts of which one is a removable part (16) retractable so as to provide a “roadway” position and a “person transport” position.

13. All-terrain light motorized vehicle according to claim 7, characterized in that the stretcher support (15) is telescopic, it comprises a chassis (15) in two parts of which one is a removable part (16) retractable so as to provide a “roadway” position and a “person transport” position.

14. All-terrain light motorized vehicle according to claim 7, characterized in that the chassis (15) comprises securement means (21) for a strap for holding a person placed on the stretcher (105) in place on the stretcher carrier.

15. All-terrain light motorized vehicle according to claim 8, characterized in that the chassis (15) comprises securement means (21) for a strap for holding a person placed on the stretcher (105) in place on the stretcher carrier.

16. All-terrain light motorized vehicle according to claim 9, characterized in that the chassis (15) comprises securement means (21) for a strap for holding a person placed on the stretcher (105) in place on the stretcher carrier.
